(19) United States
(12) Patent Application Publication
(10) Pub. No.: US 2005/0147933 A1
(43) Pub. Date: Jul. 7, 2005

(54) Color motion picture print film

(75) Inventors: Brian H. Johnston, Pittsford, NY (US); Kathleen R.C. Gisser, Pittsford, NY (US)

Correspondence Address: Paul A. Leipold;Eastman Kodak Company, 343 State Street, Rochester, NY, 14650-2201, US

(73) Assignee: Eastman Kodak Company

(21) Appl. No.: 10/749,825

(22) Filed: Dec. 31, 2003

(51) Int. Cl. G03C 1/46

(52) U.S. Cl. 430/505; 430/567

(57) ABSTRACT

Processing color motion picture film to yield a dye-only, “silverless” soundtrack enables reduced silver levels to be incorporated into all three color image records of a motion picture print film while still providing a good soundtrack signal in the resulting processed film. A silver halide light sensitive motion picture photographic print element is disclosed comprising a support bearing on one side thereof: a blue color sensitive, yellow dye image-forming record comprising at least one blue-sensitive silver halide emulsion having associated therewith yellow dye-forming coupler; a red color sensitive, cyan dye image-forming record comprising at least one red-sensitive silver halide emulsion having associated therewith cyan dye-forming coupler; and a green color sensitive, magenta dye image-forming record comprising at least one green-sensitive silver halide emulsion having associated therewith magenta dye-forming coupler; wherein each of the silver halide emulsions have an average grain size of less than 1 micrometer and comprise at least 50 mol percent chloride, based on silver, the silver halide emulsions in total comprise from 500-1350 mg/m² silver, the cyan, magenta and yellow dye-forming couplers are present at levels sufficient to provide visual densities of at least 3.3 when completely consumed, the silver to dye-forming coupler stoichiometric equivalent molar ratio in each of the image-forming records is less than 1.4, and the silver to dye-forming coupler stoichiometric equivalent molar ratio in at least one of the image-forming records is less than 1.0.

### FIELD OF THE INVENTION

The invention relates to a color motion picture print silver halide photographic film, and more particularly to such a film which has reduced silver levels designed for processing in a redox amplification development process. The invention further relates to a method for recording and processing image area frames and an optical soundtrack in such a color motion picture print film.

### BACKGROUND

Color photographic silver halide materials are processed by a process which includes a color development step. In conventional color development, silver halide is reduced to metallic silver in the light-exposed areas and the oxidized color developer formed in this reaction then couples with a color coupler and forms image dye. In such conventional development, the maximum amount or dye produced is stoichiometrically proportional to the amount of silver halide reduced to metallic silver, and the type of dye-forming coupler employed. For so-called “2-equivalent” couplers, two mols of silver are required to form one mol of dye. For “4-equivalent” couplers, four mols of silver are required to form one mol dye.

In recent years there has been a trend to reduce the amount of silver contained in photographic materials, while still generating sufficient dye images. There are various reasons why this has been done and these include reducing costs, reducing the thickness of silver halide emulsion layers, gaining sharpness, and improving the environmental impact. One class of low silver photographic materials are color materials intended for redox amplification processes wherein the developed silver acts as a catalyst to the formation of dye image. Redox amplification processes have been described, for example, in U.S. Pat. Nos. 3,674,490, 3,765,891, 3,822,129, 3,748,138, 4,088,486 and 4,954,425, and in Research Disclosure, December 1973, Page 109 No. 11660. In such processes, low silver containing color materials are developed to produce a silver image and then treated with an amplifying solution to form a dye image. The amplifying solution is usually combined with the developer to form the so-called developer-amplifier solution. The developer-amplifier solution contains a reducing agent, for example a color developing agent, and an oxidizing agent which will oxidize the color developing agent in the presence of the silver image which acts as a catalyst. The oxidized color developer reacts with a color coupler to form the image dye. During amplification, the silver image is used to produce greater quantities of oxidized developer by the action of the oxidizing agent on the catalytic surface provided by the silver image. The extra dye formed is said to amplify or intensify the image. Hence smaller amounts of silver halide in the photographic material are needed while still providing the desired image dye density. The amount of image produced in redox amplification processes depends on the time of treatment or the availability of color coupler, and is less dependent on the amount of silver in the image as is the case in conventional color development processes. Examples of suitable oxidizing agents include peroxy compounds including hydrogen peroxide, cobalt (III) complexes including cobalt hexamine complexes, and periodates. Mixtures of such compounds can also be used.

A serious problem with developer-amplifier solutions, however, is their stability. Because they contain both an oxidizing agent (e.g., the peroxide) and a reducing agent (the color developing agent), they may react together spontaneously leading to loss of activity in a short period of time. Various means to stabilize the developer-amplifier processing solution have been described. Such means include the use of metal sequestrants as described in U.S. Pat. No. 5,702,873 which reduces the degree to which metal ions catalyze the reaction of peroxide, the use of high pH as described in U.S. Pat. No. 6,114,101 which slows the oxidation reaction, the use of borate and silicate buffers as described in U.S. Pat. Nos. 5,667,947 and 5,731,135, zinc ions as described in U.S. Pat. No. 5,821,037 and the use of hydroxylamine sulfate, as the anti-oxidant or preservative agent as described in U.S. Pat. No. 6,303,279.

Alternatively, means to overcome the instability of the developer-amplifier solution include modifications to commercial photoprocessing tanks and equipment, for example the use of low volume thin tanks has been described in U.S. Pat. Nos. 5,387,499, 5,361,114, 5,382,995, 5,319,410 and 5,475,461 that require use of less than 1 liter and as little as 100 ml of solution permitting the use of unstable processing chemistry. Indeed, substantial effort has been applied to address the constraints bought on by the use of a developer-amplifier that effective solutions employ configurations where the ratio of tank volume to maximum area of material accomodatable therein (i.e., maximum path length times width of material) is less than 11 dm³/m² and preferably less than 3 dm³/m².

An alternative to a single solution is where the developer is used in a first bath followed by an amplifier bath. The amount of dye formed in such a system, however, is limited by the amount of color developing agent carried over into the second bath from the first. In order to provide sufficient color developer solely through carry-over, it would be necessary to have a level of color developing agent in the developer bath that would be too high for continuous running. U.S. Pat. No. 5,324,624 teaches the use of a developer bath followed by a developer-amplification bath. While not completely eliminating stability problems, use of the described process has the effect of lowering the needed concentration of the components of the developer-amplifier and contributing to improved solution stability. In this way low silver reflective color print materials are developed with 4-N-ethyl-N-(beta-methanesulfonamidoethyl)-o-toluidine sesquisulfate (color developer CD-3) as the specific color developing agent under conditions suitable for the commercial use of a color paper minilab photoprocessor.

Motion picture print film, the film that is shown in movie theaters, commonly employs an optical analog soundtrack along an edge of the film. During projection of the motion picture images, a light source illuminates the analog soundtrack and a photosensor senses the light passing through and modulated by the soundtrack to produce an audio signal that is sent to amplifiers of the theater sound system. While the most common soundtracks are of the “variable area” type wherein the signal is recorded in the form of a varying ratio of opaque to relatively clear area along the soundtrack, “variable density” soundtracks are also known wherein the absolute density is uniformly varied along the soundtrack. Common sound systems incorporate a photodiode in the projector whose radiant sensitivity peaks at approximately 800-950 nm (depending on the type of photodiode), which detects the predominant infra-red (IR) radiation emitted by common tungsten lamps.

A dye soundtrack may be formed in color motion picture film in accordance with conventional exposing and color development processing. Such dye soundtracks may be formed in multiple photosensitive emulsion layers of the motion picture film, or may be restricted to a single emulsion layer as set forth in U.S. Pat. No. 2,176,303. In order to provide effective modulation of common projector soundtrack illumination light, however, motion picture print film is typically processed according to a complex system wherein the optical analog soundtrack area of the print film is developed differently from the picture image frame area so that a silver image is left in the soundtrack area of the film, whereas all the silver is removed in the picture frame area, leaving only a dye image. The silver image may be reformed selectively in the soundtrack area of the film through selective application of a second developer solution after initial uniform color development (which develops exposed silver halide in both the picture area and soundtrack area up to silver metal and generates image dye), stop bath and fixer (arrests development and removes undeveloped silver halide), and bleach (converts exposed, developed silver back to silver halide in both the picture area and soundtrack area) steps. The second development step typically comprises application of a thick, viscous solution of a conventional black and white developer with a cellulose compound such as nitrosyl in a stripe solely onto the soundtrack area of the film, causing the silver halide in the soundtrack area to be selectively developed back into silver metal, while not affecting the silver halide in the image area. A subsequent fixing step then removes the silver halide from the image area, while leaving a silver image corresponding to the soundtrack exposure. Various other techniques are also known for retaining silver in the soundtrack area, but all such approaches invariably entail certain processing disadvantages, such as critical reactant concentration control and area-selective reactant application requirements. Examples of such techniques, e.g., are set forth in U.S. Pat. Nos. 2,220,178, 2,341,508, 2,763,550, 3,243,295, 3,705,799, and 4,139,382.

U.S. Pat. No. 4,219,615 suggests the use of a color amplification development process for photographic films which contain reduced silver levels in some, but not all of the emulsion layers of the element, such that a sound track with a high silver image may be formed in at least one layer of the element upon processing. While the objective of providing photographic films with overall reduced silver levels is obtained to a degree, the use of a film with color records having both reduced and conventional high silver levels introduces further complexities into color balancing requirements, as the different color records may react substantially differently to changes in process conditions. Further, the proposed process and photographic elements do not eliminate the need for special processing in the sound track area relative to the scene image areas of the exposed film.

It has also been shown that where development amplification processes are designed for processing low silver color papers, for example those having about 200 mg/m² or less of silver, such processes generally cannot be used to process conventional color papers that typically contain from 500 to 700 mg/m² because gross overamplification would occur. Similar compatibility problems would be expected for processing of conventional relatively high silver level motion picture print films with an amplified development process designed specifically for use with relatively low silver level color print films. U.S. Pat. No. 5,871,891 teaches a means to process both low silver and conventional higher silver photographic recording materials using the same processing apparatus, where the developer solution is modified depending upon the type of photographic material being processed. While such technique may be practical for use in processing of color paper materials when using processing apparatus employing relatively low development solution volume, it would not be practical for use in processing of motion picture color print films, which are typically processed in apparatus employing relatively high solution volumes.

It would be desirable to provide a color motion picture print silver halide photographic film which has reduced silver levels designed for processing in a redox amplification development process, which meet desired requirements for color print films to be viewed in transmission, typically illuminated by a xenon light source, which materials must have uniquely high visual density and neutrality in the Dmax. It would be further desirable to provide a system and method for recording and processing such a reduced silver color motion picture film having both image area frames and an optical soundtrack which provides simplified processing requirements.

### SUMMARY OF THE INVENTION

We have found that by processing color motion picture film to yield a dye-only, “silver-less” soundtrack, reduced silver levels may be incorporated into all three color image records of a motion picture print film while still providing a good soundtrack signal in the resulting processed film. The invention enables reduced silver levels to be employed in a print film, and a simplified processing procedure which does not require special processing of the exposed soundtrack relative to the image area frames.

One embodiment of the invention is directed towards a silver halide light sensitive motion picture photographic print element comprising a support bearing on one side thereof: a blue color sensitive, yellow dye image-forming record comprising at least one blue-sensitive silver halide emulsion having associated therewith yellow dye-forming coupler; a red color sensitive, cyan dye image-forming record comprising at least one red-sensitive silver halide emulsion having associated therewith cyan dye-forming coupler; and a green color sensitive, magenta dye image-forming record comprising at least one green-sensitive silver halide emulsion having associated therewith magenta dye-forming coupler; wherein each of the silver halide emulsions have an average grain size of less than 1 micrometer and comprise at least 50 mol percent chloride, based on silver, the silver halide emulsions in total comprise from 500-1350 mg/m² silver, the cyan, magenta and yellow dye-forming couplers are present at levels sufficient to provide visual densities of at least 3.3 when completely consumed, the silver to dye-forming coupler stoichiometric equivalent molar ratio in each of the image-forming records is less than 1.4, and the silver to dye-forming coupler stoichiometric equivalent molar ratio in at least one of the image-forming records is less than 1.0.

A second embodiment of the invention comprises a method for recording and processing image area frames and an optical soundtrack in a color motion picture film according to the first embodiment by imagewise exposing the color sensitive records in accordance with desired image area frames, exposing at least one of the color sensitive records in accordance with an analog soundtrack, and processing the exposed film in a development amplification process to yield corresponding dye images in the exposed image area frames and analog soundtrack; wherein said film is processed to yield a dye-only, silverless analog soundtrack, the soundtrack region of the film not being subjected to any specialized processing treatment relative to the image area frame region.

### DETAILED DESCRIPTION

In motion picture color printing, there are usually three records to record simultaneously in the image area frame region of a print film, i.e., red, green and blue. The original record to be reproduced is preferably an image composed of sub-records having radiation patterns in different regions of the spectrum. Typically it will be a multicolor record composed of sub-records formed from cyan, magenta and yellow dyes. The principle by which such materials form a color image are described in James, The Theory of the Photographic Process, Chapter 12, Principles and Chemistry of Color Photography, pp 335-372, 1977, Macmillan Publishing Co. New York, and suitable materials useful to form original records are described in Research Disclosure, December, 1987, Item 17643, published by Industrial Opportunities Ltd., Homewell Havant, Hampshire, P09 1EF, United Kingdom, and Research Disclosure, September 1994, Item 36544, published by Kenneth Mason Publications, Ltd., Emsworth, Hampshire P010 7DQ, England. Materials in which such images are formed can be exposed to an original scene in a camera, or can be duplicates formed from such camera origination materials, such as records formed in color negative intermediate films such as those identified by the tradenames Eastman Color Intermediate Films 2244, 5244 and 7244. The peak absorptions for such films are in the blue region of the spectrum at about 440 nm, in the green region of the spectrum at about 540 nm, and in the red region of the spectrum at about 680 nm.

The motion picture print film of the invention comprise a support bearing on one side thereof: a blue color sensitive, yellow dye image-forming record comprising at least one blue-sensitive (approx. 380-500 nm) silver halide emulsion having associated therewith yellow dye-forming coupler; a red color sensitive, cyan dye image-forming record comprising at least one red-sensitive (approx. 600-760 nm) silver halide emulsion having associated therewith cyan dye-forming coupler; and a green color sensitive, magenta dye image-forming record comprising at least one green-sensitive (approx. 500-600 nm) silver halide emulsion having associated therewith magenta dye-forming coupler. Each of the cyan, magenta, and yellow image forming records may be comprised of a single light-sensitive layer, a pack of two light-sensitive layers with one being more light sensitive and the other being less light-sensitive, or a pack of three or more light-sensitive layers of varying light-sensitivity. These layers can be combined in any order depending upon the specific features designed in the photographic element. The element can contain additional layers, such as filter layers, interlayers, overcoat layers, subbing layers, antihalation layers, antistatic layers, and the like.

In the following discussion of suitable materials for use in the emulsions and elements that can be used in conjunction with the invention, reference will be made to Research Disclosure, September 1994, Item 36544, available as described above, which will be identified hereafter by the term “Research Disclosure.” The contents of the Research Disclosure, including the patents and publications referenced therein, are incorporated herein by reference, and the Sections hereafter referred to are Sections of the Research Disclosure, Item 36544.

Suitable silver halide emulsions and their preparation as well as methods of chemical and spectral sensitization are described in Sections I, and III-IV. Vehicles and vehicle related addenda are described in Section II. Dye image formers and modifiers are described in Section X. Various additives such as UV dyes, brighteners, luminescent dyes, antifoggants, stabilizers, light absorbing and scattering materials, coating aids, plasticizers, lubricants, antistats and matting agents are described, for example, in Sections VI-IX. Layers and layer arrangements, color negative and color positive features, scan facilitating features, supports, exposure and processing can be found in Sections XI-XX.

Photographic light-sensitive elements may utilize silver halide emulsion image forming layers wherein chloride, bromide and/or iodide are present alone or as mixtures or combinations of at least two halides. The combinations significantly influence the performance characteristics of the silver halide emulsion. In accordance with the invention, each of the light sensitive silver halide emulsions employed in the image forming records of the print film have an average grain size equivalent circular diameter (ECD) of less than 1 micrometer (where the ECD of a grain is the diameter of a circle having the area equal to the projected area of a grain) and comprise at least 50 mol percent chloride (preferably at least 80 mol %, and more preferably at least 90 mol % chloride), based on silver. The ECDs of silver halide emulsion grains employed in the color print film elements of the invention are preferably less than 0.60 micron (more preferably less than 0.4 micron) in red and green sensitized layers and less than 1.0 micron (more preferably less than 0.8 micron) in blue sensitized layers. Such fine grain emulsions used in print elements generally have an aspect ratio of less than 1.3, where the aspect ratio is the ratio of a grain's ECD to its thickness, although higher aspect ratio grains may also be used. Such grains may take any regular shapes, such as cubic, octahedral or cubo-octahedral (i.e., tetradecahedral) grains, or the grains can take other shapes attributable to ripening, twinning, screw dislocations, etc. Typically, print element emulsions grains are bounded primarily by {110} crystal faces, since {100} silver chloride grain faces are exceptionally stable. Specific examples of high chloride emulsions used for preparing photographic prints are provided in U.S. Pat. Nos. 4,865,962; 5,252,454; and 5,252,456, the disclosures of which are here incorporated by reference.

Such relatively small, relatively high chloride emulsions are preferred for low granularity performance and environmental processing advantages. As explained in Atwell, U.S. Pat. No. 4,269,927, e.g., silver halide with a high chloride content possesses a number of highly advantageous characteristics. For example, high chloride silver halides are more soluble than high bromide silver halide, thereby permitting development to be achieved in shorter times. Furthermore, the release of chloride into the developing solution has less restraining action on development compared to bromide and iodide and this allows developing solutions to be utilized in a manner that reduces the amount of waste developing solution. Since print films are intended to be exposed by a controlled light source, the imaging speed gain which would be associated with high bromide emulsions offers little benefit for such print films.

Photographic print films which comprise relatively small grain, high chloride emulsions (e.g., emulsions having average grain size equivalent circular diameters of less than about 1 micron and halide contents of greater than 50 mole % chloride) as discussed above in order to optimize print image quality and enable rapid processing typically result in relatively low speed photographic elements in comparison to camera negative origination films. Low speed is compensated for by the use of relatively high intensity print lamps or lasers for exposing such print elements. For comparison purposes, it is noted that motion picture color print films, e.g., when rated using the same international standards criteria used for rating camera negative films, would typically have an ISO speed rating of less than 10, which is several stops slower than the slowest camera negative films in current use.

Couplers that may be used in the elements of the invention can be defined as being 4-equivalent or 2-equivalent depending on the number of atoms of Ag⁺ required to form one molecule of dye. A 4-equivalent coupler can generally be converted into a 2-equivalent coupler by replacing a hydrogen at the coupling site with a different coupling-off group. Coupling-off groups are well known in the art. Such groups can modify the reactivity of the coupler. Such groups can advantageously affect the layer in which the coupler is coated, or other layers in the photographic recording material, by performing, after release from the coupler, functions such as dye formation, dye hue adjustment, development acceleration or inhibition, bleach acceleration or inhibition, electron transfer facilitation, color correction and the like. Representative classes of such coupling-off groups include, for example, chloro, alkoxy, aryloxy, hetero-oxy, sulfonyloxy, acyloxy, acyl, heterocyclyl, sulfonamido, mercaptotetrazole, benzothiazole, alkylthio (such as mercaptopropionic acid), arylthio, phosphonyloxy and arylazo. These coupling-off groups are described in the art, for example, in U.S. Pat. Nos. 2,455,169; 3,227,551; 3,432,521; 3,476,563; 3,617,291; 3,880,661; 4,052,212 and 4,134,766; and in U.K. Patents and published Application Nos. 1,466,728; 1,531,927; 1,533,039; 2,006,755A and 2,017,704A, the disclosures of which are incorporated herein by reference.

Image dye-forming couplers may be included in elements of the invention such as couplers that form cyan dyes upon reaction with oxidized color developing agents which are described in such representative patents and publications as: U.S. Pat. Nos. 2,367,531; 2,423,730; 2,474,293; 2,772,162; 2,895,826; 3,002,836; 3,034,892; 3,041,236; 4,883,746 and “Farbkuppler-Eine Literature Ubersicht,” published in Agfa Mitteilungen, Band III, pp. 156-175 (1961). Preferably such couplers are phenols and naphthols that form cyan dyes on reaction with oxidized color developing agent. Also preferable are the cyan couplers described in, for instance, European Patent Application Nos. 544,322; 556,700; 556,777; 565,096; 570,006; and 574,948.

Couplers that form magenta dyes upon reaction with oxidized color developing agent which can be incorporated in elements of the invention are described in such representative patents and publications as: U.S. Pat. Nos. 2,600,788; 2,369,489; 2,343,703; 2,311,082; 2,908,573; 3,062,653; 3,152,896; 3,519,429 and “Farbkuppler-Eine Literature Ubersicht,” published in Agfa Mitteilungen, Band III, pp. 126-156 (1961). Preferably such couplers are pyrazolones, pyrazolotriazoles, or pyrazolobenzimidazoles that form magenta dyes upon reaction with oxidized color developing agents. Especially preferred couplers are 1H-pyrazolo [5,1-c]-1,2,4-triazole and 1H-pyrazolo [1,5-b]-1,2,4-triazole. Examples of 1H-pyrazolo [5,1-c]-1,2,4-triazole couplers are described in U.K. Patent Nos. 1,247,493; 1,252,418; 1,398,979; U.S. Pat. Nos. 4,443,536; 4,514,490; 4,540,654; 4,590,153; 4,665,015; 4,822,730; 4,945,034; 5,017,465; and 5,023,170. Examples of 1H-pyrazolo [1,5-b]-1,2,4-triazoles can be found in European Patent Applications 176,804; 177,765; U.S. Pat. Nos. 4,659,652; 5,066,575; and 5,250,400.

Couplers that form yellow dyes upon reaction with oxidized color developing agent and which are useful in elements of the invention are described in such representative patents and publications as: U.S. Pat. Nos. 2,875,057; 2,407,210; 3,265,506; 2,298,443; 3,048,194; 3,447,928 and “Farbkuppler-Eine Literature Ubersicht,” published in Agfa Mitteilungen, Band III, pp. 112-126 (1961). Such couplers are typically open chain ketomethylene compounds. Also preferred are yellow couplers such as described in, for example, European Patent Application Nos. 482,552; 510,535; 524,540; 543,367; and U.S. Pat. No. 5,238,803.

To control the migration of various components coated in a photographic layer, including couplers, it may be desirable to include a high molecular weight hydrophobe or “ballast” group in the component molecule. Representative ballast groups include substituted or unsubstituted alkyl or aryl groups containing 8 to 40 carbon atoms. Representative substituents on such groups include alkyl, aryl, alkoxy, aryloxy, alkylthio, hydroxy, halogen, alkoxycarbonyl, aryloxcarbonyl, carboxy, acyl, acyloxy, amino, anilino, carbonamido (also known as acylamino), carbamoyl, alkylsulfonyl, arysulfonyl, sulfonamido, and sulfamoyl groups wherein the substituents typically contain 1 to 40 carbon atoms. Such substituents can also be further substituted. Alternatively, the molecule can be made immobile by attachment to a polymeric backbone.

It may be useful to use a combination of couplers any of which may contain known ballasts or coupling-off groups such as those described in U.S. Pat. Nos. 4,301,235; 4,853,319 and 4,351,897.

In addition to the light sensitive dye forming layers, the print film used in accordance with the invention may include further features and layers as are known in the art. For example, antihalation and antistatic layers may be included on either side of the support, along with additional conventional interlayers and overcoat layers. Preferred supports for the print films comprise transparent polymeric films, such as cellulose nitrate and cellulose esters (such as cellulose triacetate and diacetate), polycarbonate, and polyesters of dibasic aromatic carboxylic acids with divalent alcohols such as poly(ethylene terephthalate). It is further specifically contemplated that the print elements of the invention may comprise antihalation and antistatic layers and associated compositions as set forth in U.S. Pat. Nos. 5,650,265, 5,679,505, and 5,723,272, the disclosures of which are incorporated by reference herein. Alternatively, an antihaltion comprising a hydrophilic colloid and silver as described in U.S. Pat. No. 5,753,402 may be employed. Antistatic layers comprising polythiophene which exhibit a conductivity shift upon processing such as described in U.S. Pat. No. 6,440,654, the disclosure of which is incorporated by reference herein, are also specifically contemplated. If desired, the print films can be used in conjunction with an applied magnetic layer as described in Research Disclosure, November 1992, Item 34390 published by Kenneth Mason Publications, Ltd., Dudley House, 12 North Street, Emsworth, Hampshire P010 7DQ, ENGLAND.

Further in accordance with the invention, the silver halide emulsions employed in the image forming records of the print film in total comprise from 500-1350 mg/m² silver (preferably at least 800 and more preferably at least 900 mg/m², and preferably at most 1250 and more preferably at most 1150 mg/m²), the cyan, magenta and yellow dye-forming couplers are present at levels sufficient to provide visual densities of at least 3.3 when completely consumed, the silver to dye-forming coupler stoichiometric equivalent molar ratio in each of the image-forming records is less than 1.4 (preferably less than 1.3, and more preferably less than 1.2), and the silver to dye-forming coupler stoichiometric equivalent molar ratio in at least one (and preferably at least two) of the image-forming records is less than 1.0 (preferably less than 0.9, more preferably less than 0.8). Such requirements define a unique motion picture print film which enables the production of desirably high density images with good granularity while employing low silver levels. If silver levels are substantially below about 500 mg/m², visual densities of greater than 3.3 may be difficult to consistently and robustly be obtained even with amplified development processing. If the silver levels are above 1350, as well as if the silver to dye-forming coupler stoichiometric ratios in one or more records are above the stated requirements, advantages of reduced silver levels are compromised. Visual densities of at least 3.3 (preferably at least 3.6, and more preferably at least 3.8) are required to provide sufficient black densities.

For the purposes of the invention, the silver to dye-forming coupler stoichiometric ratio is defined as the ratio of the mols of silver halide to the moles of dye-forming coupler in a particular color record, divided by the equivalency of the dye-forming coupler (i.e., divided by 2 for 2-equivalent couplers, and divided by 4 for 4-equivalent couplers). Coupler equivalency is well-known and established in the photographic art. In contrast to the present invention, in conventional print films intended for processing with conventional development, in order to account for development inefficiencies while also enabling coupling of substantially all imaging coupler employed, the silver to dye-forming coupler stoichiometric equivalent molar ratio in each of the image-forming records is typically greater than 1.0, and is further typically greater than 1.2 (commonly greater than 1.3 and frequently greater than 1.4) in at least one (and commonly in at least two) of the image-forming records. The print films of the invention specifically employ relatively lower ratios of silver to the amount of image forming couplers present.

In accordance with one embodiment of the invention, the image area frame region of the print film is conventionally imagewise exposed to produce a latent image in the red, green and blue light photosensitive layers of the print film. The soundtrack region of the print film is exposed to produce a latent image corresponding to an analog soundtrack in at least one photosensitive layer of the print film. While the analog sound track may be recorded in more than one photosensitive layer of the print film (e.g., in both the red and green light sensitive layers as is conventionally practiced), in a preferred embodiment of the invention the exposure is limited to a single photosensitive layer through choice of soundtrack exposing light, filters, etc. In a most preferred embodiment of the invention, only the red light photosensitive cyan dye forming layer is exposed in accordance with the analog soundtrack. This may be conveniently done through use of a red light emitting diode laser in recording the soundtrack.

After the motion picture print films are exposed, they are processed in accordance with one embodiment of the present invention with a redox amplification development process employing an oxidizing agent in combination with a color developing agent to form a visible color image in the image area frame region of the film and a silverless “dye only” analog soundtrack. Processing a silver halide color photographic light-sensitive material in accordance with the invention is basically composed of 1) amplified color development and 2) desilvering.

As described in the prior art, examples of suitable oxidizing agents for use in redox amplified development processes include peroxy compounds including hydrogen peroxide, cobalt (III) complexes including cobalt hexamine complexes, and periodates. Amplified color development of color print films in accordance with the present invention may be achieved by modifying conventional color print film development processes, which typically will employ KODAK Color Developing Agent CD-2 (N,N-diethyl p-phenylenediamine sulfate) as more fully described in Kodak Publication No. H-24, Manual For Processing Eastman Color Films, the disclosure of which is hereby incorporated by reference, by the incorporation of the oxidizing agent in the main developer solution step, or in a pre- or post-developer processing bath. In accordance with a preferred embodiment, the oxidizing agent is introduced in a development amplifier step conducted after a main color developer step, as more fully discussed in co-pending, concurrently-filed, commonly assigned U.S. Ser. No. ______ (Kodak Docket No. 84785), the disclosure of which is incorporated by reference herein. While conventional development processing of current commercially available color print films results in processing efficiency (E) values typically of less than 2.5 (where (E) values are calculated using the formula: E=(Dye Image Dmax)/(Silver coverage, g/m²)), in such preferred process, relatively low silver color print films such as those of the present invention may be processed to provide processing efficiency (E) values of from 2.5 to 6.7, more preferably 2.5 to 5.0 and most preferably 3.0 to 5.0, while also maintaining visual Dmin less than 0.1 and the Equivalent Neutral Density (END) Dmax values for the cyan and yellow color records within 20% (more preferably within 15% and most preferably within 10%) of the END Dmax value for the green color record, which is desired for obtaining adequate color balance when developed print film images are projected with a xenon light source. END value for any particular dye color record is defined as the visual density that results when the other two dyes are added in quantities just sufficient to produce a neutral gray (see, e.g., “Procedures for Equivalent-Neutral-Density (END) Calibration of Color Densitometers Using a Digital Computer”, by Albert J. Sant, in the Photographic Science and Engineering, Vol. 14, Number 5, September-October 1970, pg. 356).

The desilvering stage comprises a bleaching step to change the developed silver back to an ionic-silver state and a fixing step to remove the ionic silver from the light-sensitive material. The bleaching and fixing steps can be combined into a monobath bleach-fix step that can be used alone or in combination with the bleaching and the fixing step. If necessary, additional processing steps may be added, such as a washing step, a stopping step, a stabilizing step and a pretreatment step. The processing chemicals may be liquids, pastes, or solids, such as powders, tablets or granules.

Print film processing in accordance with one embodiment of the invention is characterized in that the soundtrack region of the film is not subjected to any specialized processing treatment relative to the image area frame region. As previously explained, the formation of a silver sound track on a color motion picture film in accordance with conventional practice requires additional special processing steps to retain the silver solely in the sound track region of the film, which are not needed in accordance with the present invention. Such processing is described for the Kodak ECP-2D Process, e.g., in Kodak Publication No. H-24, Manual For Processing Eastman Color Films, the disclosure of which is hereby incorporated by reference. Such previously performed steps no longer needed in accordance with the invention include, e.g., soundtrack drying, soundtrack applicator, soundtrack developer, and soundtrack spray rinse steps. A dye only soundtrack is simply developed in the soundtrack region of the print film as the dye images are formed in the image area frame region.

Due to the spectral differences between the silver and the dye only soundtracks, in accordance with a further preferred embodiment of the invention, the projector systems currently used for films containing silver soundtracks are modified for use with the motion picture print films exposed and processed in accordance with the invention to contain a dye-only soundtrack to improve the performance of the dye-only soundtrack. Most existing sound motion picture projectors incorporate a photodiode in the projector whose radiant sensitivity peaks at approximately 800-950 nanometers (depending on the type of photodiode) to detect the predominant infra-red (IR) radiation emitted by the tungsten lamp and modulated by the film's variable area silver soundtrack. A dye only sound track, however, will modulate light predominantly in the visible region of the spectrum. Although the photodiodes have some sensitivity in the visible range (approximately 380-760 nanometers) of the radiation spectrum, their lower sensitivity in this range, coupled with the lower emission of the light source in the visible range results in a very low input to the sound amplifier. The situation is further aggravated by the fact that the density range between the “clear” minimum density (Dmin) area and the “opaque” maximum density (Dmax) area of a variable area analog soundtrack is less for the dye only soundtrack. If the signal is too low for the amplification stage to operate properly (e.g. signal-to-noise loss), the sound quality will be degraded.

Improved performance for the dye-only soundtracks of the invention can be achieved, e.g., by using the modified soundtrack interface apparatus for a motion picture projectors as described in U.S. Pat. No. 5,483,306, the disclosure of which is hereby incorporated by reference. Alternatively, or additionally, improved performance for the dye-only soundtracks of the invention can be achieved by recording and developing the soundtrack in a single photosensitive layer of the print film, and recovering the signal from the dye only soundtrack using a narrow band (e.g., 10-30 nm bandwidth) light source the wavelength of which is chosen so as to coincide with the peak absorbance wavelength of the soundtrack dye. Where the cyan layer of the print film is used to record the soundtrack, e.g., a narrow band red light source would be used for reading the developed soundtrack. A red light emitting diode may be conveniently used for reading cyan dye-only soundtracks, e.g., as has been recently proposed by Dolby Laboratories in an announcement at the Association of Cinema and Video Laboratories (ACVL) Jun. 1-3, 1995 convention at Lake Tahoe, Nev. The use of such relatively monochromatic light sources for the soundtrack reader in combination with a single layer dye soundtrack maximizes the relative optical density difference between the dyed areas and the undyed transparent areas of the soundtrack while maintaining high contrast. While a conventional tungsten light source may perform poorly with a dye only soundtrack due to the relatively low signal generated in the solar cell of the soundtrack reader resulting from the poor modulation of the tungsten light by the image dyes, the use of a narrow monochromatic light source eliminates the presence of unmodulated light outside the absorbance spectrum of the dye only soundtrack striking the solar cell, thereby improving the modulation signal generated by the solar cell.

The following examples illustrate preparation of photographic elements of the present invention, and their beneficial characteristics.

### COMPARISON EXAMPLE 1

This example demonstrates the typical range of visual Dmax, Silver content and Efficiency of conventional commercially available color print films when processed according to the manufacturer's recommendations.

Commercially available color print film elements 101, 102, 103, and 104 were exposed for 1/500s on a 1-B sensitometer with a 3200K light source and a 0-3 LogE step tablet, and then processed in the standard color print process ECP-2D as described in the Kodak Publication H-24, Module 9; using a persulfate bleach, omitting the first fix and subsequent wash, and without any sound track application. The ECP-2D process employed comprised a Color Developer step (3′), stop bath (40″), wash (40″), bleach accelerator (20″), persulfate bleach (40″), wash (40″), fix (40″), wash (1′), final rinse (10″), and then drying with hot air. Processing of the exposed elements is done with the color developing solution adjusted to 36.7° C. (98 F). The stopping, fixing, bleaching, washing, and final rinsing solution temperatures are adjusted to 26.7° C. (80 F).

The ECP-2D Color Developer comprises:

| | |
|---|---|
| Kodak Anti-Calcium, No. 4 (40% solution of a pentasodium | 1.00 mL |
| salt of nitrilo-tri(methylene phosphonic acid) | |
| Sodium sulfite (anhydrous) | 4.35 g |
| Sodium bromide (anhydrous) | 1.72 g |
| Sodium carbonate (anhydrous) | 17.1 g |
| Kodak Color Developing Agent, CD-2 | 2.95 g |
| Water to make 1 liter | |
| pH @ 26.7° C. is 10.53 +/− 0.05 | |

The visual Dmax was calculated from the Status A red, green and blue values according to the method in ISO Standard 5-3, using the standard Illuminant A. Silver content was measured by wavelength dispersive X-ray Fluorescence in unprocessed film. The efficiency is calculated by the following equation: (1000*Visual Dmax)/(Silver Content, mg/m²), and represents the amount of silver that is necessary to achieve a particular Visual Density. Higher efficiencies are desirable because the minimum amount of silver in the film may be used to reach the desired Dmax.

TABLE 1

| | Visual | Silver Content | |
|---|---|---|---|
| Element | Dmax | (mg/m²) | Efficiency |
| 101 | 3.80 | 1636 | 2.32 |
| 102 | 4.75 | 2389 | 1.98 |
| 103 | 3.61 | 1453 | 2.48 |
| 104 | 3.27 | 1377 | 2.37 |

Elements 101-104 demonstrate that useful levels of Visual Dmax (3.27 to 4.7) are currently accessible with commercially available relatively high silver coverage (greater than 1350 mg/m²) films that have efficiencies below 2.5 when processed with standard color print development process ECP-2D.

### EXAMPLE 2

Comparison photographic color print film Element 105 (total silver halide emulsion coverage 1471 mg/m², based on silver) was prepared according to the following formulation:

| | |
|---|---|
| Protective Overcoat | |
| Gelatin | 976 |
| Polydimethylsiloxane lubricant (Dow Corning) | 16 |
| Polymethylmethacrylate beads | 16 |
| Spreading Aids | |
| Green Emulsion Layer | |
| AgClBr cubic grain emulsion GE-1, 1.35% Br, 0.14 micron, | 68 |
| spectrally sensitized with green sensitizing dye GSD-1, | |
| 0.363 mmole/Ag mole, and green sensitizing | |
| dye GSD-2, 0.012 mmole/Ag mole. | |
| AgClBr cubic grain emulsion GE-2, 1.2% Br, 0.18 micron, | 316 |
| spectrally sensitized with green sensitizing dye | |
| GSD-1, 0.293 mmole/Ag mole, and green | |
| sensitizing dye GSD-2, 0.009 mmole/Ag mole. | |
| AgClBr cubic grain emulsion GE-3, 1.7% Br, 0.26 micron, | 57 |
| spectrally sensitized with green sensitizing | |
| dye GSD-1, 0.273 mmole/Ag mole, and green | |
| sensitizing dye GSD-2, 0.008 mmole/Ag mole. | |
| Magenta Dye Forming Coupler M-1 | 648 |
| Green Filter Dye GFD-2 | 54 |
| Oxidized Developer Scavenger Scav-1 | 16 |
| Gelatin | 1426 |
| Interlayer | |
| Oxidized Developer Scavenger Scav-1 | 48 |
| Gelatin | 610 |
| Spreading aids | |
| Red Emulsion Layer | |
| AgClBr cubic grain emulsion RE-1, 0.8% Br, 0.14 micron, | 60 |
| spectrally sensitized with red sensitizing | |
| dye RSD-1, 0.042 mmole/Ag mole. | |
| AgClBr cubic grain emulsion RE-2, 0.9% Br, 0.18 micron, | 218 |
| spectrally sensitized with red sensitizing dye RSD-1, | |
| 0.044 mmole/Ag mole. | |
| AgClBr cubic grain emulsion RE-3, 0.9% Br, 0.26 micron, | 122 |
| spectrally sensitized with red sensitizing dye RSD-1, | |
| 0.050 mmole/Ag mole. | |
| Cyan dye forming coupler C-1 | 888 |
| Red Absorber Dye | 63 |
| Gelatin | 2859 |
| Interlayer | |
| Oxidized Developer Scavenger Scav-1 | 48 |
| Gelatin | 610 |
| Spreading aids | |
| Blue Emulsion Layer | |
| AgClBr cubic grain emulsion BE-1, 0.4% Br, 0.40 micron, | 126 |
| spectrally sensitized with blue sensitizing dye BSD-1, 0.151 | |
| mmole/Ag mole and blue sensitizing dye BSD-2, | |
| 0.149 mmole/Ag mole. | |
| AgClBr cubic grain emulsion BE-2, 0.5% Br, 0.50 micron, | 297 |
| spectrally sensitized with blue sensitizing dye BSD-1, | |
| 0.219 mmole/Ag mole and blue sensitizing | |
| dye BSD-2, 0.217 mmole/Ag mole. | |
| AgClBr cubic grain emulsion BE-3, 0.3% Br, 0.90 micron, | 208 |
| spectrally sensitized with blue sensitizing dye BSD-1, | |
| 0.124 mmole/Ag mole and blue sensitizing | |
| dye BSD-2, 0.122 mmole/Ag mole. | |
| Yellow Coupler (Y-1) | 1315 |
| Blue filter dye BFD-1 | 30 |
| Yellow Preformed Dye YPD-1 | 7 |
| Gelatin | 2395 |
| Antihalation Layer | |
| Antihalation Filter Dye AFD-1 | 56 |
| Antihalation Filter Dye AFD-2 | 129 |
| Gelatin | 759 |
| Spreading aids | |
| Support | |
| Transparent polyethylene terephthalate support with polyurethane | |
| overcoated Baytron P ™ (available from Bayer | |
| Corporation) antistatic layer on the back of the film base | |
| which provides process surviving antistatic properties. | |

The following structures represent compounds utilized in the above described photographic element.

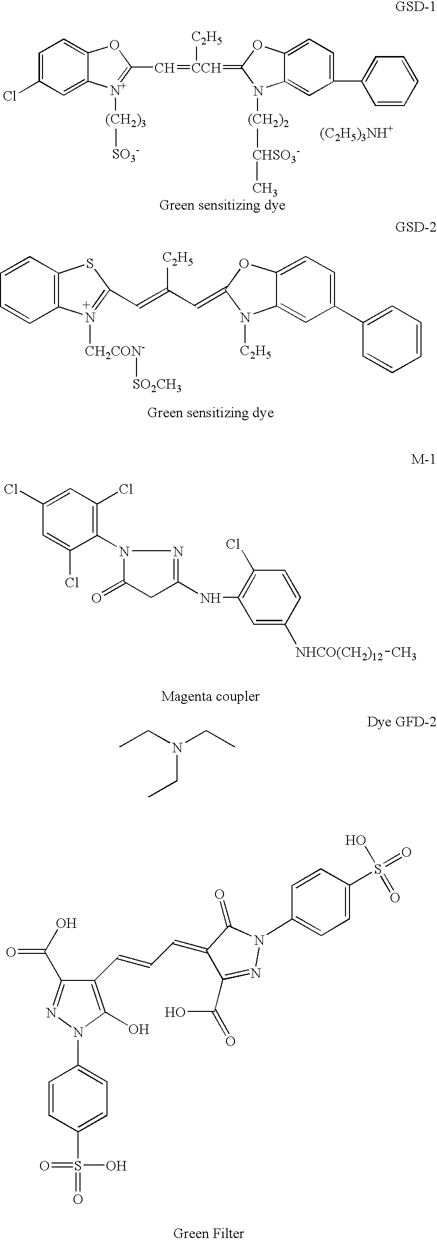

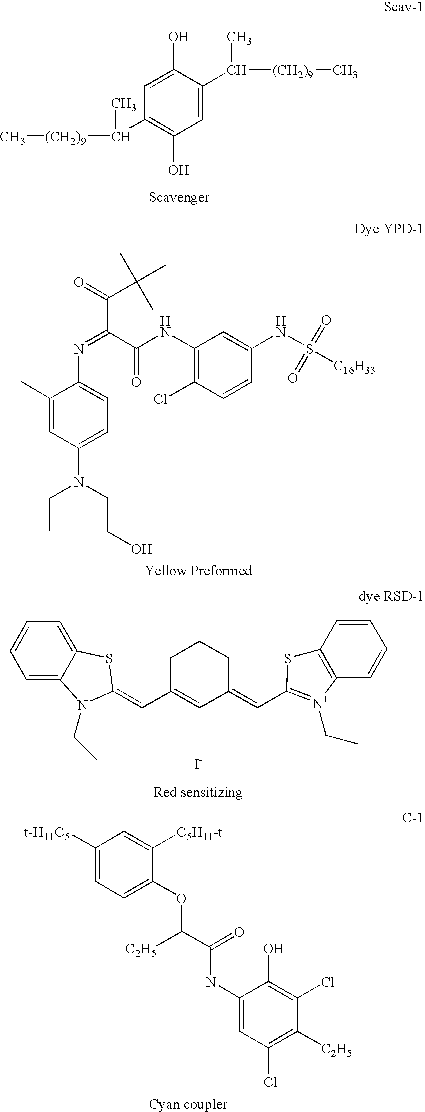

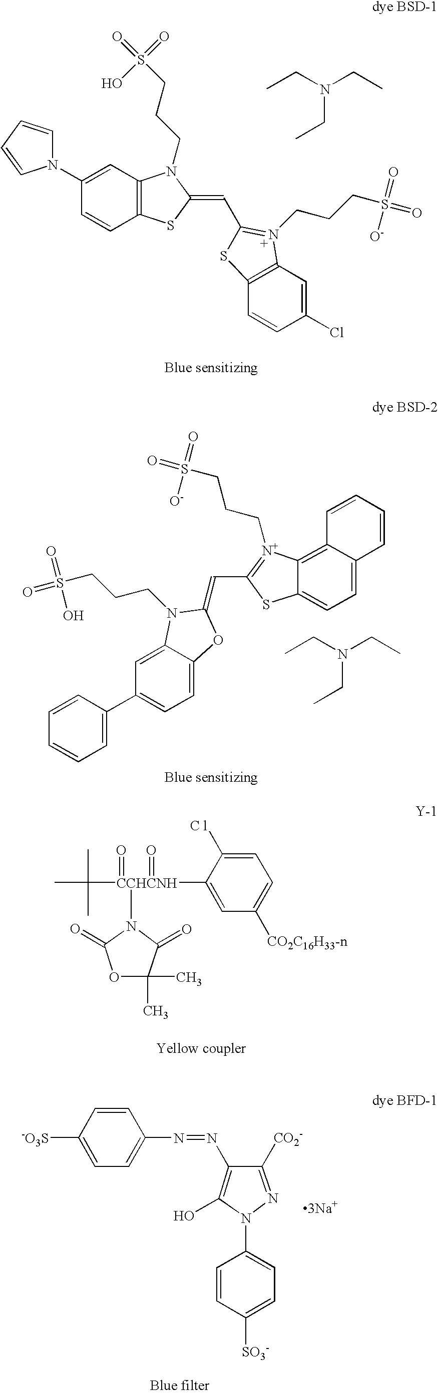

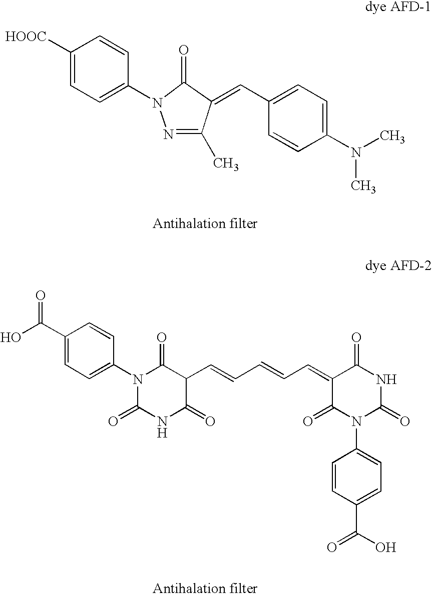

Photographic color print film Elements 106-109 in accordance with the invention (total silver halide emulsion coverage 500-1350 mg/m², based on silver) and Comparison Element 110 (total silver halide emulsion coverage 490 mg/m², based on silver) were prepared similarly to Element 105, but by varying the silver levels, coupler level and emulsion levels as indicated in Table 2A below:

TABLE 2A
(Laydowns in mg/m²)

| | Green | | Red | | Blue | |
|---|---|---|---|---|---|---|
| | Emulsion, | | Emulsion, | | Emulsion, | |
| | (Percent | | (Percent | | (Percent | |
| | GE-3, GE-2, | Magenta | RE-3, RE-2, | Cyan | BE-3, BE-2, | Yellow |
| Element | GE-1) | Coupler | RE-1) | Coup | BE-1) | Coupler |
| 105 | 442 | 648 | 400 | 888 | 632 | 1315 |
| | (15.5, 71.5, 13) | | (15, 54.5, 30.5) | | (20, 47, 33) | |
| 106 | 368 | 619 | 330 | 844 | 510 | 1258 |
| | (15.5, 71.5, 13) | | (15, 54.5, 30.5) | | (20, 49.5, 30.5) | |
| 107 | 344 | 648 | 311 | 888 | 491 | 1315 |
| | (15.5, 71.5, 13) | | (15, 54.5, 30.5) | | (20, 47, 33) | |
| 108 | 339 | 664 | 279 | 817 | 452 | 1304 |
| | (13, 80, 7) | | (0, 81.5, 18.5) | | (0, 80, 20) | |
| 109 | 245 | 648 | 222 | 888 | 351 | 1315 |
| | (15.5, 71.5, 13) | | (15, 54.5, 30.5) | | (20, 47, 33) | |
| 110 | 147 | 648 | 133 | 888 | 210 | 1315 |
| | (15.5, 71.5, 13) | | (15, 54.5, 30.5) | | (20, 47, 33) | |

Elements 105-110 were processed according to an amplified development process comprising a Color Developer I step (1′), an Amplifier I step (1′), stop bath (40″), wash (40″), bleach accelerator (20″), persulfate bleach (40″), wash (40″), fix (40″), wash (1′), final rinse (10″), and then drying with hot air. Processing of the exposed elements is done with the color developing and amplifier solutions adjusted to 36.7° C. The stopping, fixing, bleaching, washing, and final rinsing solution temperatures are adjusted to 26.7° C.

The Color Developer I comprises:

| | |
|---|---|
| Kodak Anti-Calcium, No. 4 (40% solution of a pentasodium | 1.00 mL |
| salt of nitrilo-tri(methylene phosphonic acid) | |
| Sodium sulfite (anhydrous) | 4.35 g |
| Sodium bromide (anhydrous) | 1.3 g |
| Sodium carbonate (anhydrous) | 17.1 g |
| Kodak Color Developing Agent, CD-2 | 3.1 g |
| Sulfuric acid (7.0N) | 0.62 mL |
| Water to make 1 liter | |
| pH @ 26.7° C. is 10.65 +/− 0.05 | |

The Amplifier I comprises:

| | |
|---|---|
| Kodak Anti-Calcium, No. 4 (40% solution of a pentasodium | 1.00 mL |
| salt of nitrilo-tri(methylene phosphonic acid) | |
| Sodium carbonate (anhydrous) | 17.1 g |
| H₂O₂ (30%) | 12 g |
| Color Developer I | 80 mL |
| Water to make 1 liter | |
| pH @ 26.7° C. is 10.8 +/− 0.05 | |

After processing, the visual density and efficiency were measured as described above. The films were then read for Status A densitometry, and to calculate the color balance, the Status A densitometry was converted to Equivalent Neutral Densitometry using the method as described in the article “Procedures for Equivalent-Neutral-Density (END) Calibration of Color Densitometers Using a Digital Computer”, by Albert J. Sant, in the Photographic Science and Engineering, Vol. 14, Number 5, September-October 1970, pg. 356-362. The END values for the highest density step are reported in the Table 2B below.

TABLE 2B

| | | | | Ag/ | | | | |
|---|---|---|---|---|---|---|---|---|
| | | | | Coup | | | Total | |
| | | Silver | | Equiv | | | Silver | |
| | Color | mg/ | Coupler | mol | END | Visual | mg/ | |
| Elem. | Rec. | m² | mg/m² | ratio | Dmax | Dmax | m² | E |
| 105 | Green | 440 | 648 | 0.97 | 4.05 | 3.94 | 1471 | 2.68 |
| | Red | 396 | 888 | 1.06 | 3.69 | | | |
| | Blue | 635 | 1316 | 1.46 | 3.90 | | | |
| 106 | Green | 368 | 619 | 0.85 | 4.06 | 3.92 | 1208 | 3.25 |
| | Red | 330 | 844 | 0.93 | 3.65 | | | |
| | Blue | 510 | 1258 | 1.23 | 3.77 | | | |
| 107 | Green | 342 | 648 | 0.76 | 4.06 | 3.91 | 1144 | 3.42 |
| | Red | 308 | 888 | 0.82 | 3.65 | | | |
| | Blue | 494 | 1316 | 1.14 | 3.82 | | | |
| 108 | Green | 339 | 664 | 0.73 | 3.80 | 3.80 | 1070 | 3.55 |
| | Red | 279 | 817 | 0.81 | 3.70 | | | |
| | Blue | 452 | 1304 | 1.05 | 3.79 | | | |
| 109 | Green | 245 | 648 | 0.54 | 3.51 | 3.73 | 817 | 4.57 |
| | Red | 220 | 888 | 0.59 | 3.63 | | | |
| | Blue | 353 | 1316 | 0.81 | 3.59 | | | |
| 110 | Green | 147 | 648 | 0.32 | 2.75 | 2.70 | 490 | 5.51 |
| | Red | 132 | 843 | 0.37 | 2.57 | | | |
| | Blue | 212 | 1304 | 0.49 | 2.71 | | | |

Example 2B shows that visual densities at Dmax of at least 3.3 can be easily achieved for print elements having total silver level above 500 mg/m², with efficiencies between 2.5 and 6.7. All of the inventive examples also have adequate color balance with the END Dmax of the red and blue records within 20% of the END Dmax of the green record.

Element 108 demonstrates that within the scope of the invention, changes to the distribution of the silver and coupler between the red, green, and blue sensitive layers, as well as the ratio of emulsion types may be used to adjust the color balance at Dmax.

### EXAMPLE 3

Elements 109 and 110 were processed similarly as described in as described in Example 2, except employing Color Developer II in place of Color Developer I, and Amplifier II in place of Amplifier I.

The Color Developer II comprises:

| | |
|---|---|
| Kodak Anti-Calcium, No. 4 (40% solution of a pentasodium | 1.00 mL |
| salt of nitrilo-tri(methylene phosphonic acid) | |
| Sodium sulfite (anhydrous) | 4.35 g |
| Sodium bromide (anhydrous) | 0.5 g |
| Sodium carbonate (anhydrous) | 17.1 g |
| Kodak Color Developing Agent, CD-2 | 3.7 g |
| Sulfuric acid (7.0N) | 0.62 mL |
| Water to make 1 liter | |
| pH @ 26.7° C. is 10.65 +/− 0.05 | |

The Amplifier II comprises:

| | |
|---|---|
| Kodak Anti-Calcium, No. 4 (40% solution of a pentasodium | 1.00 mL |
| salt of nitrilo-tri(methylene phosphonic acid) | |
| Sodium carbonate (anhydrous) | 17.1 g |
| H₂O₂ (30%) | 15 g |
| Color Developer II | 10 mL |
| Water to make 1 liter | |
| pH @ 26.7° C. is 10.8 +/− 0.05 | |

The results obtained are reported in Table 3:

TABLE 3

| | Visual | Silver Content | |
|---|---|---|---|
| Element | Dmax | (mg/m²) | Efficiency |
| 110 | 3.78 | 490 | 7.71 |
| 109 | 3.94 | 817 | 4.82 |

The above data demonstrates that process changes may be used to enhance the efficiency of the elements with the lowest silver content. By altering the process, the efficiency of comparison element 110, e.g., may be increased until the visual Dmax is within the desired range for a print film. However, a wide variability of the Dmax dependent upon process changes is not necessarily desirable, as motion picture films are generally processed in large laboratories and the film is expected to be perform relatively invariant to process changes. While Element 109 within the scope of the invention demonstrates some process dependency, it does so to a much less extent.

### EXAMPLE 4

Typically, reducing the silver in an element processed in a standard development process reduces the speed and the contrast of the film to an unacceptable level. This is demonstrated by a comparison of commercially available color print film Element 101 (1636 mg/m² silver) and Element 107 in accordance with the invention (1144 mg/m² silver) processed without amplification as described in Example 1. In an amplified process, Element 107 in accordance with the invention regains its speed, as demonstrated by the processing of Element 107 through an amplified development process as described in Example 2, and even surpasses conventionally processed Element 101 by more than half a stop in the blue record, as indicated by the data in Table 4, where delta speed is 100 times the difference in loge necessary to reach density of 1.0. However, the contrast of element 107 is even lower after amplified development than it is in the non-amplified process. By adjusting the ratio of the emulsions, as well as the amount of silver and coupler in each color record, however, as done in Element 108, the speed of a reduced silver print film element may be made to remain higher than that of the conventionally processed Element 101, while achieving contrasts within 5% of such conventional element. In combination with the Dmax levels of Element 108 (from Example 2 above) this insures that acceptable images may be obtained on the screen. Since contrast also affects granularity, the granularity (σ_{d}) and contrast for Elements 101, 107 and 108 were measured at a density of 1.0 and (1000*σ_{d}/contrast) as reported in the Table 4 below.

TABLE 4

| | | | | | | | | | | | (1000 * σ_{d}/ | | |
|---|---|---|---|---|---|---|---|---|---|---|---|---|---|
| | | Average grain | | | Δ Speed at | | | Δ contrast (%) | | | contrast) at | | |
| | | size (microns) | | | Density = 1.0 | | | at Density = 1.0 | | | Density = 1.0 | | |
| Element | Process | R | G | B | R | G | B | R | G | B | R | G | B |
| 101 | Ex. 1 | — | — | — | 0 | 0 | 0 | 0.0 | 0.0 | 0.0 | 5.78 | 6.02 | 14.63 |
| 107 | Ex. 1 | 0.18 | 0.18 | 0.55 | −13 | −16 | −12 | −11.5 | −16.0 | −20.3 | 6.72 | 7.21 | 21.90 |
| 107 | Ex. 2 | 0.18 | 0.18 | 0.55 | 4.1 | −2 | 23 | −24.5 | −21.2 | −28.5 | 7.13 | 6.47 | 30.22 |
| 108 | Ex. 2 | 0.17 | 0.19 | 0.48 | 3 | 6 | 17 | −1.4 | −3.8 | 4.7 | 5.44 | 5.27 | 11.08 |

On a contrast-normalized basis, the granularity of Element 107 is worse (higher) than that of Element 101 when processed through the standard ECP-2D process. The disparity is even worse in the red and blue records when Element 107 is processed through the amplified process described in Example 2. Reducing granularity is most easily done by reducing the grain size, but this reduces the photographic speed of the element. Because the speed of Elements 107 and 108 in the amplified process are faster than that of Element 101 in the ECP-2D process, the blend ratio of the emulsions may be changed to reduce the amount of fast emulsion, and in the case of the blue record, to substantially reduce the average grain size in the layer without falling below the desired speed. The resulting granularity of Element 108 when processed in the amplified process is comparable to that of Element 101 when conventionally processed through ECP-2D.

### EXAMPLE 5

Color print film Elements 106-109 described in Example 2 are imagewise exposed in accordance with desired image area frames, and the cyan dye forming layer is exposed in accordance with a variable area analog soundtrack. The exposed films are then processed according to the amplified development process described in Example 2 to yield corresponding dye images in the image area frames, and a dye-only, silverless analog soundtrack. The films yield acceptable results for sensitometry, halation latitude, sharpness, and graininess. The film also yields acceptable audio performance for a dye-only soundtrack.

While the invention has been described in detail with particular reference to preferred embodiments, it will be understood that variations and modifications can be effected within the spirit and scope of the invention.

1. A silver halide light sensitive motion picture photographic print element comprising a support bearing on one side thereof: a blue color sensitive, yellow dye image-forming record comprising at least one blue-sensitive silver halide emulsion having associated therewith yellow dye-forming coupler; a red color sensitive, cyan dye image-forming record comprising at least one red-sensitive silver halide emulsion having associated therewith cyan dye-forming coupler; and a green color sensitive, magenta dye image-forming record comprising at least one green-sensitive silver halide emulsion having associated therewith magenta dye-forming coupler; wherein each of the silver halide emulsions have an average grain size of less than 1 micrometer and comprise at least 50 mol percent chloride, based on silver, the silver halide emulsions in total comprise from 500-1350 mg/m² silver, the cyan, magenta and yellow dye-forming couplers are present at levels sufficient to provide Visual densities of at least 3.3 when completely consumed, the silver to dye-forming coupler stoichiometric equivalent molar ratio in each of the image-forming records is less than 1.4, and the silver to dye-forming coupler stoichiometric equivalent molar ratio in at least one of the image-forming records is less than 1.0.

2. A print element according to claim 1, wherein the cyan, magenta and yellow dye-forming couplers are present at levels sufficient to provide Visual densities of at least 3.6 when completely consumed.

3. A print element according to claim 1, wherein the cyan, magenta and yellow dye-forming couplers are present at levels sufficient to provide Visual densities of at least 3.8 when completely consumed.

4. A print element according to claim 1, wherein silver halide emulsions of the dye image-forming records comprise a total level of from 500-1250 mg/m² silver.

5. A print element according to claim 1, wherein silver halide emulsions of the dye image-forming records comprise a total level of from 800-1250 mg/m² silver.

6. A print element according to claim 1, wherein silver halide emulsions of the dye image-forming records comprise a total level of from 800-1150 mg/m² silver.

7. A print element according to claim 1, wherein silver halide emulsions of the dye image-forming records comprise a total level of from 900-1150 mg/m² silver.

8. A print element according to claim 1, wherein the silver to dye-forming coupler stoichiometric equivalent molar ratio in each of the image-forming records is less than 1.3, and the silver to dye-forming coupler stoichiometric equivalent molar ratio in at least two of the image-forming records is less than 1.0.

9. A print element according to claim 1, wherein the silver to dye-forming coupler stoichiometric equivalent molar ratio in each of the image-forming records is less than 1.2, and the silver to dye-forming coupler stoichiometric equivalent molar ratio in at least two of the image-forming records is less than 0.9.

10. A print element according to claim 1, wherein the silver to dye-forming coupler stoichiometric equivalent molar ratio in each of the image-forming records is less than 1.2, and the silver to dye-forming coupler stoichiometric equivalent molar ratio in at least one of the image-forming records is less than 0.8.

11. A print element according to claim 1, wherein the silver to dye-forming coupler stoichiometric equivalent molar ratio in each of the image-forming records is less than 1.0.

12. A print element according to claim 1, wherein each of the red-sensitive and green-sensitive silver halide emulsions comprise emulsion grains having an average equivalent circular diameter of less than 0.60 micron, and the blue-sensitive silver halide emulsion comprises emulsion grains having an average equivalent circular diameter of less than 1.0 micron.

13. A print element according to claim 1, wherein each of the red-sensitive and green-sensitive silver halide emulsions comprise emulsion grains having an average equivalent circular diameter of less than 0.40 micron, and the blue-sensitive silver halide emulsion comprises emulsion grains having an average equivalent circular diameter of less than 0.80 micron.

14. A method for recording and processing image area frames and an optical soundtrack in a color motion picture print film according to claim 1, said method comprising: imagewise exposing the color sensitive records in accordance with desired image area frames, exposing at least one of the color sensitive records in accordance with an analog soundtrack, and processing the exposed film in a development amplification process to yield corresponding dye images in the exposed image area frames and analog soundtrack; wherein said film is processed to yield a dye-only, silverless analog soundtrack, the soundtrack region of the film not being subjected to any specialized processing treatment relative to the image area frame region.

15. The method of claim 14, wherein the soundtrack is recorded and developed in a single color record of the print film.

16. The method of claim 15, further comprising reading the developed dye only soundtrack using a narrow band light source the wavelength of which coincides with the peak absorbance wavelength of the soundtrack dye.

17. The method of claim 15, wherein said soundtrack is exposed in said single color record with a light source corresponding to the peak sensitivity of the color record.

18. The method of claim 17, wherein said single color record is the red-light sensitive color record and the exposing light source is a red light emitting diode laser.

19. The method of claim 1, wherein the film processing comprises an initial development step and a subsequent development amplification step.
